(19) United States
(12) Patent Application Publication
(10) Pub. No.: US 2025/0095889 A1
(43) Pub. Date: Mar. 20, 2025

(54) SURGE PROTECTION DEVICE INCLUDING MULTIPLE VARISTOR WAFERS WITH COORDINATED ELECTRICAL CHARACTERISTICS TO REDUCE CURRENT IMBALANCE DURING RESPONSE TO OVERVOLTAGE EVENTS

(71) Applicant: RAYCAP IP DEVELOPMENT LTD, Strovolos (CY)

(72) Inventors: Antony J. Surtees, Chagrin Falls, OH (US); Jacob Andersen, Cataldo, ID (US); Brian J. Chamberlin, Coeur d'Alene, ID (US); Marko Tomšic, Ljubljana (SI); James A. Wilson, Coeur d'Alene, ID (US)

(21) Appl. No.: 18/468,766

(22) Filed: Sep. 18, 2023

(51) Int. Cl. H01C 7/112; H01C 7/12; H01C 17/00

(52) U.S. Cl. CPC H01C 7/112; H01C 7/12; H01C 17/006

(57) ABSTRACT

A surge protection device (SPD) module includes: a housing; a plurality of metal oxide varistor (MOV) wafers, respective ones of the plurality of MOV wafers having electrical characteristics that reduce an imbalance in current between the respective ones of the plurality of MOV wafers in response to an overvoltage event; and one or more electrodes, the plurality of MOV wafers and the one or more electrodes being alternately arranged in the housing.

### FIELD

The present inventive concepts relate generally to surge protection devices and, more particularly, to surge protection device modules.

### BACKGROUND

A varistor, short for “variable resistor.” is an electronic component that is used to protect other electronic components from voltage spikes or surges. It is also known as a voltage-dependent resistor or VDR. A varistor is made of a semiconductor material, typically metal oxide, which has a highly nonlinear current-voltage characteristic. This means that its resistance changes rapidly with changes in voltage. When the voltage across the varistor is below a certain threshold, it presents a very high resistance, acting almost like an open circuit. But when the voltage exceeds this threshold, the resistance drops significantly, allowing current to flow through it. When a voltage surge or transient occurs, the varistor quickly becomes conductive, providing a low-impedance path for the excess current to protect the sensitive electronic components. This effectively clamps the voltage to a safe level and protects the circuit from damage. Varistors are commonly used in power supplies, surge protectors, and electronic equipment to protect against lightning strikes, electrostatic discharge, and other voltage surges that can damage or destroy sensitive components. They are also used in electronic circuits to stabilize voltage levels and reduce noise. Overall, a varistor is a simple but effective component that often plays a crucial role in protecting electronic equipment from damage caused by voltage surges and spikes.

Varistors may be constructed to have different designs for different applications. For industrial applications (e.g., surge current capacity in the range 36 to 600 kA per phase), such as protection of commercial facilities, leaded varistors are commonly used. A leaded varistor typically includes a disk-shaped varistor element with conductive leads connected on either end of the varistor and coated in an insulating material, such as epoxy. The varistor disk is formed by pressure casting and sintering a metal oxide material, such as zinc oxide, or other suitable material, such as silicon carbide. Electrically conductive material may be may be screen printed on the opposing surfaces of the disk. Ring-shaped electrodes may be bonded to the two conductive surfaces and the disk and electrode assembly may be encapsulated with an insulating material. The above varistor construction can also make use of a disconnector, one for each single leaded varistor, where the current and associated heat generated during a voltage increase is isolated to the individual leaded varistors.

The above-described varistor construction, however, may perform inadequately due to the inability to withstand sufficiently high currents during an overvoltage event. As a result, multiple varistor wafers may be stacked together in a parallel array to increase the surge current withstand capacity. During high surge currents, the varistor disks may prematurely fail due to lack of coordination of the electrical characteristics between the varistor wafers in the parallel array. More specifically, the lack of coordination may lead to premature thermal runaway due to an imbalance in the current flow through each varistor in the parallel array.

### SUMMARY

According to some embodiments of the inventive concept, a surge protection device (SPD) module, comprises: a housing; a plurality of metal oxide varistor (MOV) wafers, respective ones of the plurality of MOV wafers having electrical characteristics that reduce an imbalance in current between the respective ones of the plurality of MOV wafers in response to an overvoltage event; and one or more electrodes, the plurality of MOV wafers and the one or more electrodes being alternately arranged in the housing.

In other embodiments, at least one of the MOV wafers has a different clamping voltage than another one of the MOV wafers.

In still other embodiments, at least one of the MOV wafers has a different thickness than another one of the MOV wafers.

In still other embodiments, at least one of the MOV wafers has a different material composition than another one of the MOV wafers.

In still other embodiments, at least one of the MOV wafers comprises zinc oxide or silicon carbide.

In still other embodiments, at least one of the MOV wafers has a different grain size than another one of the MOV wafers.

In still other embodiments, at least one of the MOV wafers has a different impurity doping than another one of the MOV wafers.

In still other embodiments, a first manufacturing process used to make at least one of the MOV wafers is different than a second manufacturing process used to make at least another one of the MOV wafers.

In still other embodiments, the first manufacturing process and the second manufacturing process differ in temperature or pressure.

In still other embodiments, one of the one or more electrodes includes a tab portion that is configured to extend outside the housing and is further configured to attach to a disconnector element via a conductive thermal adhesive material; and the conductive thermal adhesive material is configured to soften in response to heat applied thereto causing the tab portion to separate from the disconnector element.

In still other embodiments, a first one of the one or more electrodes includes a first tab portion configured to connect to a first connection port; and a second one of the one or more electrodes includes a second tab portion configured to connect to a second connection port.

In still other embodiments, the housing comprises an insulating material.

In still other embodiments, the insulating material is epoxy.

In some embodiments of the inventive concept, a surge protection device (SPD) assembly comprises: a base; and an SPD mounted on the base, the SPD comprising: a housing; a plurality of metal oxide varistor (MOV) wafers, respective ones of the plurality of MOV wafers having electrical characteristics that reduce an imbalance in current between the respective ones of the plurality of MOV wafers in response to an overvoltage event; and one or more electrodes, the plurality of MOV wafers and the one or more electrodes being alternately arranged in the housing.

In further embodiments, the SPD assembly further comprises: a disconnector element mounted on the base and configured to receive the overvoltage event; wherein one of the one or more electrodes includes a tab portion that is configured to extend outside the housing and is further configured to attach to the disconnector element via a conductive thermal adhesive material; and wherein the conductive thermal adhesive material is configured to soften in response to heat applied thereto causing the tab portion to separate from the disconnector element.

In further embodiments, the SPD assembly further comprises: an alert circuit mounted on the base and configured to generate an alert signal when the tab portion separates from the disconnector element.

In still further embodiments, the alert circuit includes an optical generator that is configured to generate an optical beam and an optical detection circuit that is configured to detect the optical beam; and the disconnector element includes a beam splitter tab that is configured to block the optical beam from the optical detection circuit when the disconnector element is attached to the tab portion.

In still further embodiments, the disconnector element is biased to remove the beam splitter tab from between the optical generator and the optical detection circuit responsive to the disconnector element separating from the disconnector element; and the optical detection circuit is further configured to generate the alert signal responsive to detection of the optical beam.

In still further embodiments, a first one of the one or more electrodes includes a first tab portion configured to connect to a first connection port; and a second one of the one or more electrodes includes a second tab portion configured to connect to a second connection port.

In still further embodiments, the base is a printed circuit board.

Other methods, systems, apparatus and/or articles of manufacture according to embodiments of the inventive concept will be or become apparent to one with skill in the art upon review of the following drawings and detailed description. It is intended that all such additional methods, systems, apparatus and/or articles of manufacture be included within this description, be within the scope of the present inventive concept and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1A is a perspective view metal oxide varistor (MOV) wafer stack for use in a surge protection device in accordance with some embodiments of the inventive concept;

FIG. 1B is an exploded perspective view of the MOV stack of FIG. 1A;

FIG. 1C is a perspective view of the MOV stack of FIG. 1A enclosed in a housing to form the surge protection device in accordance with some embodiments of the inventive concept;

FIG. 2 is a perspective view of a MOV stack for use in a surge protection device in which the MOV wafers have different thicknesses in accordance with some embodiments of the inventive concept;

FIG. 3A is a perspective view of two MOV stacks mounted on a base each with disconnector elements in a connected position attached thereto in accordance with some embodiments of the inventive concept;

FIG. 3B is a perspective view of two MOV stacks mounted on a base each with disconnector elements in a disconnected position in accordance with some embodiments of the inventive concept;

FIG. 4 is a perspective view of two MOV stacks mounted on a base with each MOV stack coupled to two connection ports;

FIG. 5 is a perspective view of an MOV stack with two disconnector elements in a connected position and including beam splitter tabs, respectively, in accordance with some embodiments of the inventive concept;

FIG. 6A is a circuit diagram of an alert circuit in which the disconnector element is in a connected position in accordance with some embodiments of the inventive concept; and

FIG. 6B is a circuit diagram of the alert circuit of FIG. 6A in which the disconnector element is in a disconnected position in accordance with some embodiments of the inventive concept.

### DETAILED DESCRIPTION

In the following detailed description, numerous specific details are set forth to provide a thorough understanding of embodiments of the inventive concept. However, it will be understood by those skilled in the art that embodiments of the inventive concept may be practiced without these specific details. In some instances, well-known methods, procedures, components, and circuits have not been described in detail so as not to obscure the inventive concept. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Some embodiments of the inventive concept stem from a realization that single metal oxide varistors (MOVs) used in surge protection devices are often inadequate to withstand the current that may be generated from an overvoltage event. As a result, multiple MOVs may be placed on a printed circuit board (PCB) in parallel with each other to increase the current carrying capacity of a surge protection device or assembly. Because there may not be any coordination between the electrical characteristics of the MOVs in the parallel array, one or more of the MOVs may fail due to premature thermal runaway due to an imbalance in current flowing through the individual MOVs. Some embodiments of the inventive concept may provide a surge protection device (SPD) module that includes multiple MOV wafers that respectively have electrical characteristics that reduce an imbalance in current between the different MOV wafers. This may improve the isothermal characteristics of the individual MOV wafers during an overvoltage event. Specifically, by reducing an imbalance in current flow between the varistor wafers, the current flow and resulting heat may be spread across the entire stack of MOV wafers that make up the SPD assembly in a more spatially isothermal manner or more spatially uniform manner, reducing the likelihood that one or more of the MOV wafers may fail. As a result, the current carrying capacity of the SPD in response to an overvoltage event may be increased. One or more disconnector elements may be used to couple one or more MOV wafers, respectively, to a terminal that may be the source of an overvoltage event. A conductive thermal adhesive, such as solder, that may be configured to soften in response to heat may be used to couple a disconnector element to a MOV wafer to protect the SPD if an overvoltage event causes such an increase in current that an associated isothermal temperature rise may damage the SPD assembly. When the conductive thermal adhesive softens, the disconnector element may separate from the MOV thereby disconnecting the MOV from the source of the overvoltage event. The disconnection may be due to the shared heat generated across the stack of MOV wafers included in the SPD assembly.

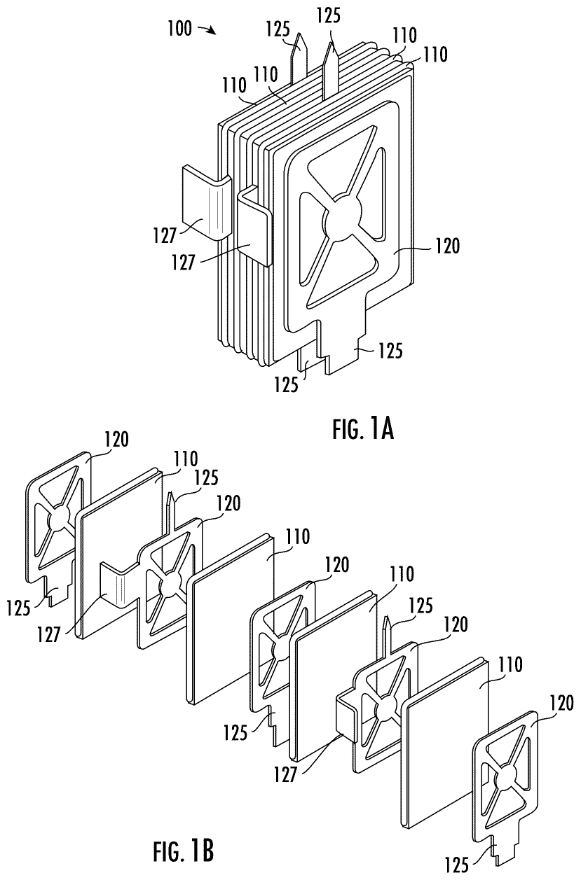

FIG. 1A is a perspective view metal oxide varistor (MOV) stack for use in a surge protection device in accordance with some embodiments of the inventive concept. FIG. 1B is an exploded perspective view of the MOV stack of FIG. 1A. As shown in FIGS. 1A and 1B, an MOV stack 100 includes a plurality of MOV wafers 110 that are alternately arranged with parallelization plates or electrodes 120 to form the varistor stack. Each of the conductive separator plates 120 may include one or more electrodes 125 and 127 that may be used for various purposes mechanical and/or electrical disconnection, printed circuit board (PCB) mounting, alignment, and/or electrical connection between the conductive separator plates. The electrodes 127 may, in some embodiments, be used as a tab for connection to a disconnector element to disconnect the varistor stack 100 from a source of an overvoltage event to protect the varistor stack 100 from thermal damage. FIG. 1C is a perspective view of the MOV stack 100 of FIGS. 1A and 1B enclosed in a housing 130 to form a surge protection device 150 in accordance with some embodiments of the inventive concept. In some embodiments, the housing 130 that encapsulates the MOV stack 100 may comprise an electrical insulating material, such as an epoxy. As shown in FIG. 1C, the electrodes 125 and 127 may not be encapsulated by the housing 130 and may instead extend from the housing 130.

In accordance with some embodiments of the inventive concept, the MOV wafers 110 comprising the MOV stack 100 may be configured to have electrical characteristics that reduce an imbalance in current between respective MOV wafers 110 in response to an overvoltage event. A variety of different factors may affect the electrical characteristics of an MOV, such as current carrying capability, clamping voltage, and the like. Thus, the MOV wafers 110 comprising the MOV stack may be intentionally configured with variations in one or more of these factors relative to each other to reduce the current imbalance between the wafers 110 in response to an overvoltage event. By reducing the current imbalance among the various MOV wafers 110 in the stack, the stack may be more spatially isothermal, i.e., heat is distributed in a more spatially uniform manner across the stack. The factors affecting the electrical characteristics of an MOV wafer 110 and/or the consequences of the MOV behavior may include, but are not limited to, the following examples:

Material composition: The composition of the metal oxide used in the MOV wafer 110 affects its voltage capacity. Generally, zinc oxide or silicon carbide may be used as the main ingredient in MOV wafers 110.

Grain size: The grain size of the metal oxide in the MOV wafer 110 affects its voltage capacity. Smaller grain sizes increase the voltage capacity of the MOV wafer 110.

Impurities: The presence of impurities in the metal oxide can affect the voltage capacity of the MOV wafer 110. Impurities can lead to defects in the crystal structure, which can reduce the voltage capacity.

Manufacturing process: The manufacturing process used to make the MOV wafer 110 can affect its voltage capacity. The temperature, pressure, and other manufacturing conditions can affect the grain size and purity of the metal oxide.

Operating conditions: The voltage capacity of an MOV wafer 110 can also be affected by the operating conditions of the circuit it is protecting. Factors such as the magnitude and duration of the surge, as well as the frequency of surges, can affect the performance of the MOV wafer 110.

Maximum continuous voltage (Vcv): This is the maximum voltage that the MOV wafer 110 can continuously withstand without breaking down. It is usually specified in volts (V).

Maximum peak voltage (Vp): This is the maximum voltage that the MOV wafer 110 can handle in a single surge event. It is usually specified in volts (V).

Clamping voltage (Vc or Vc(max)): This is the voltage level at which the MOV wafer 110 starts to conduct current and clamp the voltage during a surge event. It is usually specified in volts (V).

Energy absorption (W): This is the amount of energy that the MOV wafer 110 can absorb during a surge event without being damaged. It is usually specified in joules (J).

Response time: This is the time it takes for the MOV wafer 110 to respond and start clamping the voltage during a surge event. It is usually specified in microseconds (μs) and depends on the circuit configuration and operating conditions.

Leakage current (Ileak): This is the small amount of current that flows through the MOV wafer 110 when the circuit is under normal operating conditions. It is usually specified in microamperes (μA) and depends on the voltage applied across the MOV wafer 110.

Operating temperature range: This is the range of temperatures within which the MOV wafer 110 can operate safely and maintain its electrical properties. It is usually specified in degrees Celsius (° C.).

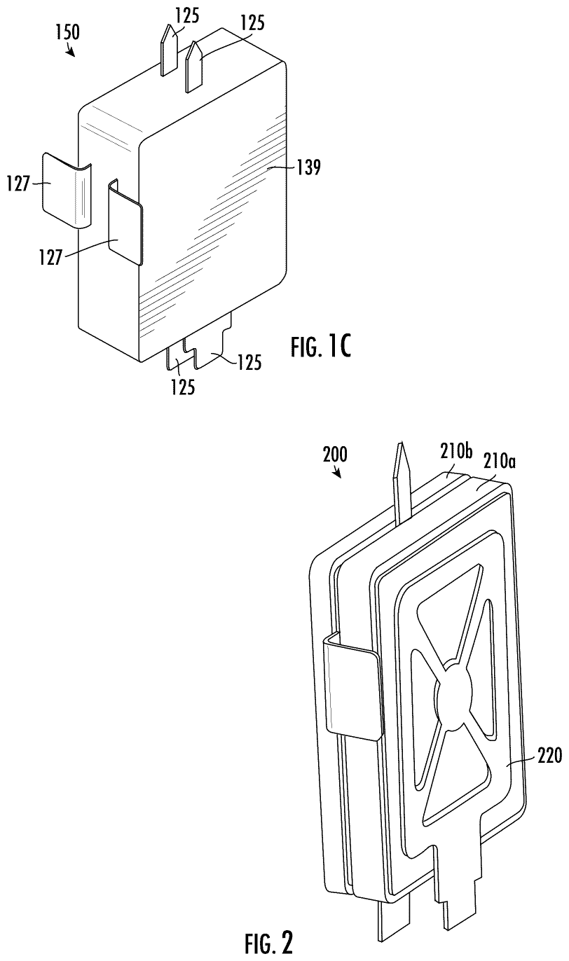

Another factor that can affect the electrical characteristics of the MOV wafer 110 is the thickness of the wafer. FIG. 2 is a perspective view of a MOV stack 200 for use in a surge protection device in which the MOV wafers 210a and 210b have different thicknesses in accordance with some embodiments of the inventive concept. As shown in FIG. 2, MOV wafer 210a is thicker than MOV wafer 210b.

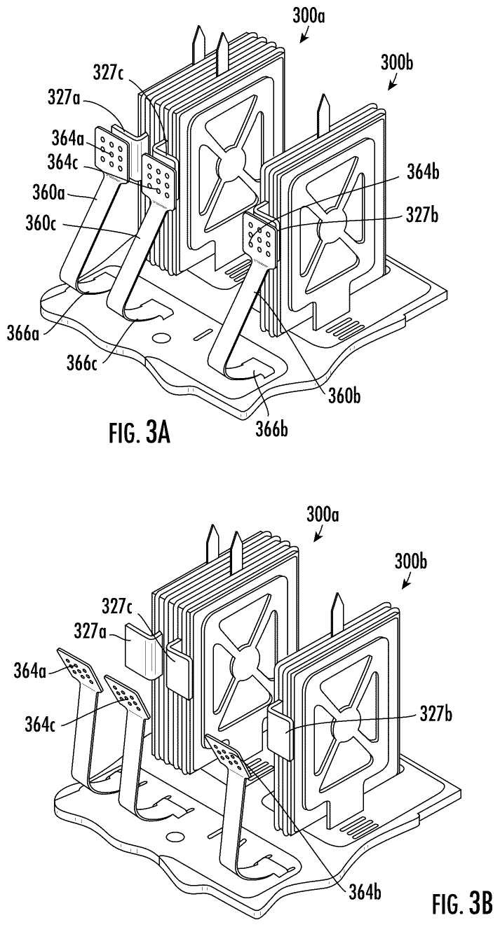

FIG. 3A is a perspective view of two MOV stacks 300a, 300b mounted on a base 355 each with disconnector elements 360a, 360b, 360c in a connected position attached thereto in accordance with some embodiments of the inventive concept. The base 355 may be a PCB in some embodiments of the inventive concept. FIG. 3B is a perspective view of the two MOV stacks 300a, 300b mounted on the base 355 each with the disconnector elements 360a, 360b, 360c in a disconnected position in accordance with some embodiments of the inventive concept. Referring to FIG. 3A, the MOV stack 300a includes two conductive plates with tab portions 327a and 327c, respectively, and the MOV stack 300b includes a conductive plate with tab portion 327b. Three disconnector elements 360a, 360b, and 360c may be configured with first ends 366a, 366b, and 366c coupled to ports that may each be a source of an overvoltage event with the other ends 364a, 364b, and 364c coupled to the tab portions 327a, 327b, and 327c, respectively. A conductive thermal adhesive, such as solder, may be used to form the attachment between the tab portions 327a, 327b, and 327c and the ends 364a, 364b, and 364c of the disconnector elements 360a, 360b, and 360c. The conductive thermal adhesive may soften in response to heat applied thereto, such as when an overvoltage event causes an increase in current that an associated isothermal temperature rise risks damage the SPD assembly. When the conductive thermal adhesive softens or melts, one or more of the disconnector elements 360a, 360b, and 360c may be biased to separate from the tab portions 327a. 327b, and 327c thereby disconnecting the MOV stack 300a and/or 300b from the source of the overvoltage event as shown in FIG. 3B. In the example of FIG. 3B, all three of the disconnector elements 360a, 360b, and 360c disconnect from the tab portions 327a, 327b, and 327c. This may protect the SPD assembly including the MOV stacks 300a and/or 300b from thermal damage caused by an overvoltage event.

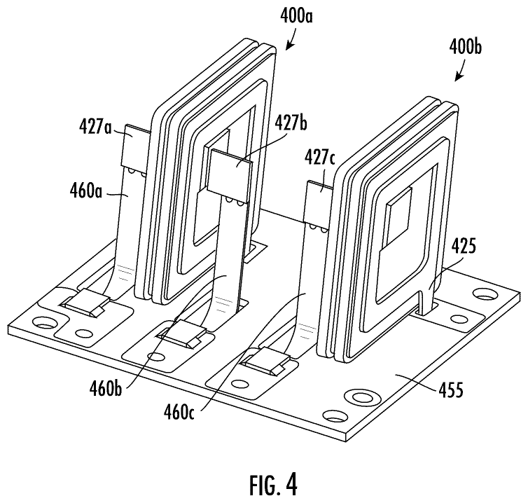

FIG. 4 is a perspective view of two MOV stacks 400a and 400b mounted on a base 455 with each MOV stack 400a, 400b coupled to two input connection ports. Specifically, the MOV stack 400a is coupled to a first connection port via tab portion 427a and disconnector element 460a and is coupled to a second connection port via tab portion 427b and disconnector element 460b. The MOV stack 400b is coupled to a third connection port via tab portion 427c and disconnector element 460c and is coupled to a fourth connection port via electrode 425. Thus, the multi-wafer MOV stacks 400a and 400b may each be coupled to multiple voltage sources simultaneously via ports on the base 455.

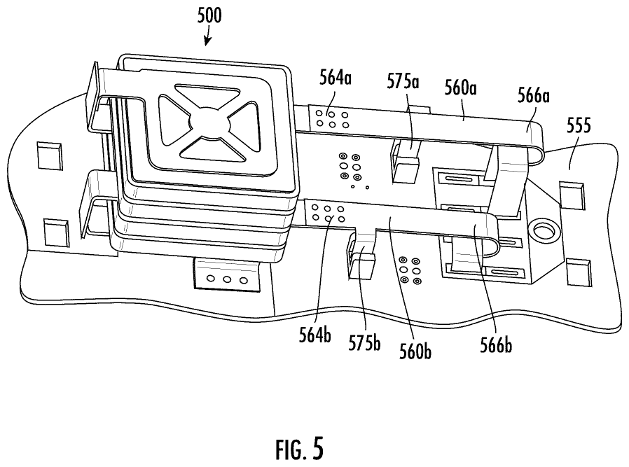

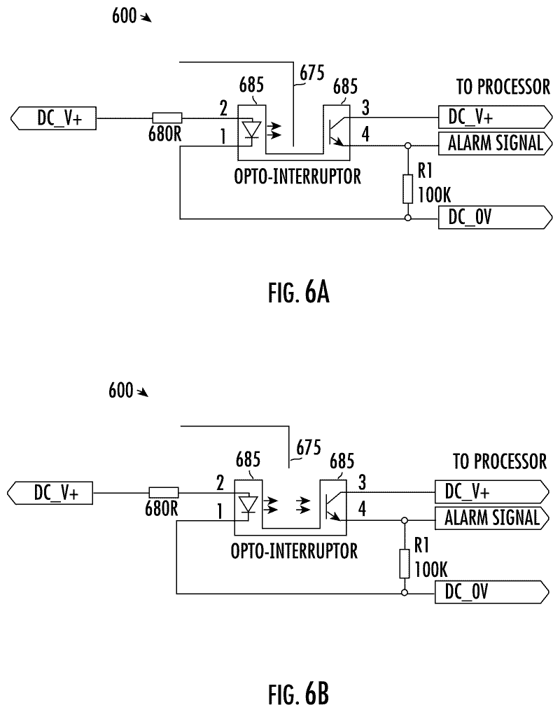

FIG. 5 is a perspective view of an MOV stack 500 with two disconnector elements 560a and 560b in a connected position according to some embodiments of the inventive concept. The two disconnector elements 560a and 560b have ends 564a and 564b, respectively, that are coupled to the MOV wafer stack 500 via a conductive thermal adhesive, such as solder, that is configured to soften in response to heat applied thereto as described above. The ends 566a and 566b may each be coupled to input connection ports that may be the source of an overvoltage event. It may be desirable to provide an alert mechanism when a disconnector element 560a and/or 560b disconnects from the MOV stack 500 due to excessive heat generated by an overvoltage event. Accordingly, in some embodiments of the inventive concept, the disconnector elements 560a and 560b may include beam splitter tabs 575a and 575b that are configured to engage an alert circuit as will be described below with reference to FIGS. 6A and 6B.

FIG. 6A is a circuit diagram of an alert circuit 600 in which the beam splitter tab 675, which may correspond to beam splitter tabs 575a and/or 575b, is in a connected position in accordance with some embodiments of the inventive concept; and FIG. 6B is a circuit diagram of the alert circuit 600 of FIG. 6A in which the beam splitter tab 675 is in a disconnected position in accordance with some embodiments of the inventive concept. The alert circuit 600 may be mounted on a base, such as the base 555 and may be configured to generate an alert signal when the tab portion of a parallelization plate or electrode separates from a disconnector element. As shown in FIG. 6A, the alert circuit 600 may comprise an optical generator 680, which may be a light emitting diode (LED) and an optical detection circuit 685, such as a photodetector. When a disconnector element is in a connected state, i.e., is connected to a tab portion of a parallelization plate or electrode of a MOV stack, the beam splitter tab 675 of a disconnector element may block the optical beam from being detected by the optical detector 685. When the disconnector element is in a disconnected state, i.e., is disconnected from the tab portion of a parallelization plate or electrode of a MOV stack, the bias in the disconnector element may cause the beam splitter tab 675 to move away from being between the optical generator 680 and the optical detection circuit 685 to allow the optical detection circuit 685 to detect the optical beam generated by the optical generator 680. In response to detecting the optical beam, the optical detection circuit 685 may generate an output signal at the emitter terminal thereof, which may be used to drive a visual and/or audible warning component and/or may be processed using a processor to notify a responsible party that an overvoltage event has occurred that has caused an SPD to overheat and be disconnected from the overvoltage event by way of a disconnector element. This may allow a responsible party to take additional action to mitigate potential damage caused by the overvoltage event.

While some embodiments of the inventive concept have been illustrated with respect to FIGS. 5, 6A, and 6B in which multiple alert circuits are configured between multiple voltage sources and a single MOV stack, embodiments of the inventive concept are not limited thereto. In other embodiments, a single alert circuit may be used between a single voltage source and multiple MOV stacks are connected in parallel. In still other embodiments, a single alert circuit may be used between a single voltage source and a single MOV stack.

Some embodiments of the inventive concept described herein may, therefore, provide an SPD module including an MOV stack that may increase the current withstand and/or overvoltage surge capacity through improved isothermal temperature management in the MOV stack. The MOV wafers in the stack may be selected in a way to provide increased coordinated conduction during overvoltage current surges by lowering the imbalance in current flow between the MOV wafers in the MOV stack.

### Further Definitions and Embodiments

In the above-description of various embodiments of the present inventive concept, it is to be understood that the terminology used herein is for the purpose of describing particular embodiments only and is not intended to be limiting of the invention. Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The terminology used herein is for the purpose of describing particular aspects only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising.” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

The description of the present inventive concept has been presented for purposes of illustration and description, but is not intended to be exhaustive or limited to the inventive concept in the form disclosed. Many modifications and variations will be apparent to those of ordinary skill in the art without departing from the scope and spirit of the inventive concept. The aspects of the inventive concept herein were chosen and described to best explain the principles of the inventive concept and the practical application, and to enable others of ordinary skill in the art to understand the inventive concept with various modifications as are suited to the particular use contemplated.

What is claimed is:

1. A surge protection device (SPD) module, comprising:
a housing;
a plurality of metal oxide varistor (MOV) wafers, respective ones of the plurality of MOV wafers having electrical characteristics that reduce an imbalance in current between the respective ones of the plurality of MOV wafers in response to an overvoltage event; and
one or more electrodes, the plurality of MOV wafers and the one or more electrodes being alternately arranged in the housing.

2. The SPD module of claim 1, wherein at least one of the MOV wafers has a different clamping voltage than another one of the MOV wafers.

3. The SPD module of claim 1, wherein at least one of the MOV wafers has a different thickness than another one of the MOV wafers.

4. The SPD module of claim 1, wherein at least one of the MOV wafers has a different material composition than another one of the MOV wafers.

5. The SPD module of claim 1, wherein at least one of the MOV wafers comprises zinc oxide or silicon carbide.

6. The SPD module of claim 1, wherein at least one of the MOV wafers has a different grain size than another one of the MOV wafers.

7. The SPD module of claim 1, wherein at least one of the MOV wafers has a different impurity doping than another one of the MOV wafers.

8. The SPD module of claim 1, wherein a first manufacturing process used to make at least one of the MOV wafers is different than a second manufacturing process used to make at least another one of the MOV wafers.

9. The SPD module of claim 1, wherein the first manufacturing process and the second manufacturing process differ in temperature or pressure.

10. The SPD module of claim 1, wherein one of the one or more electrodes includes a tab portion that is configured to extend outside the housing and is further configured to attach to a disconnector element via a conductive thermal adhesive material; and
wherein the conductive thermal adhesive material is configured to soften in response to heat applied thereto causing the tab portion to separate from the disconnector element.

11. The SPD module of claim 1, wherein a first one of the one or more electrodes includes a first tab portion configured to connect to a first connection port; and
a second one of the one or more electrodes includes a second tab portion configured to connect to a second connection port.

12. The SPD module of claim 1, wherein the housing comprises an insulating material.

13. The SPD module of claim 12, wherein the insulating material is epoxy.

14. A surge protection device (SPD) assembly, comprising:
a base; and
an SPD mounted on the base, the SPD comprising:
a housing;
a plurality of metal oxide varistor (MOV) wafers, respective ones of the plurality of MOV wafers having electrical characteristics that reduce an imbalance in current between the respective ones of the plurality of MOV wafers in response to an overvoltage event; and
one or more electrodes, the plurality of MOV wafers and the one or more electrodes being alternately arranged in the housing.

15. The SPD assembly of claim 14, further comprising:
a disconnector element mounted on the base and configured to receive the overvoltage event;
wherein one of the one or more electrodes includes a tab portion that is configured to extend outside the housing and is further configured to attach to the disconnector element via a conductive thermal adhesive material; and
wherein the conductive thermal adhesive material is configured to soften in response to heat applied thereto causing the tab portion to separate from the disconnector element.

16. The SPD assembly of claim 15, further comprising:
an alert circuit mounted on the base and configured to generate an alert signal when the tab portion separates from the disconnector element.

17. The SPD assembly of claim 16, wherein the alert circuit includes an optical generator that is configured to generate an optical beam and an optical detection circuit that is configured to detect the optical beam; and
wherein the disconnector element includes a beam splitter tab that is configured to block the optical beam from the optical detection circuit when the disconnector element is attached to the tab portion.

18. The SPD assembly of claim 17, wherein the disconnector element is biased to remove the beam splitter tab from between the optical generator and the optical detection circuit responsive to the disconnector element separating from the disconnector element; and
wherein the optical detection circuit is further configured to generate the alert signal responsive to detection of the optical beam.

19. The SPD assembly of claim 14, wherein a first one of the one or more electrodes includes a first tab portion configured to connect to a first connection port; and
wherein a second one of the one or more electrodes includes a second tab portion configured to connect to a second connection port.

20. PD assembly of claim 14, wherein the base is a printed circuit board.
